(19) United States
(12) Patent Application Publication
(10) Pub. No.: US 2021/0142640 A1
(43) Pub. Date: May 13, 2021

(54) Multilevel Automatic Distress Call System for Infants Trapped in an Automobile

(71) Applicant: Le Zhuang, Nanjing City (CN)

(72) Inventor: Le Zhuang, Nanjing City (CN)

(73) Assignee: Le Zhuang, Nanjing City (CN)

(21) Appl. No.: 17/081,176

(22) Filed: Oct. 27, 2020

(30) Foreign Application Priority Data
Nov. 13, 2019 (CN) ZL201921954751.1

(51) Int. Cl. G08B 21/02; B60R 25/01; B60R 25/10

(52) U.S. Cl. CPC G08B 21/0225; G08B 21/0208; B60R 2025/1016; B60R 25/10; B60R 25/01

(57) ABSTRACT

A multilevel automatic distress call system for infants trapped in an automobile, including a power control switch, a controller, timer switches and a first-level radio transmitter, a second-level radio transmitter and a microphone. The power control switch can be closed to put through the power supply of the multilevel automatic distress call system. The microphone is used to receive and recognize the cry of infant and startup commands to the controller. The controller is connected to the timer switches, the first-level radio transmitter, and the second-level ratio transmitter. The radio signals sent by the first-level radio transmitter is transmitted to a specific private communication equipment for an accurate alarm, while the radio signals sent by the second-level radio transmitter will be transmitted to a specific alarm platform for an emergency distress call. The system combines an accurate alarm with an emergency distress call, to help rescue the trapped infant.

### BACKGROUND OF THE INVENTION

### 1. Field of the Invention

This invention belongs to the field of automobile security technologies. Specifically, it is a multilevel automatic distress calls system, which fundamentally guarantees the life, health and safety of the infant trapped in the car due to the negligence of the adults.

### 2. Description of Related Art

With the high popularity of private cars and kindergarten school buses, as well as the increase of work pressure and social interference factors, a kind of terrible accident is on the increase all over the world. That is, when adults leave their cars, they also leave their sleeping infants behind for a long time because of gross negligence. This can be fatal to infants who are not yet able to open the doors by themselves.

Such accidents have happened many times, vehicles involving private cars as well as school buses. Just recently (July 2019), a pair of young twins lost their lives in the United States due to their father's negligence. Everyone knows this is an extremely low-level oversight, but in the grand scheme of things it is unavoidable. It is now, and may continue to be, a threat to the lives of non-specific infants and young children. This threat to the lives of infants and young children is unacceptable and must be thoroughly changed.

According to the data, previous utility model people have paid attention to such terrible disasters and proposed the corresponding technical solution (Name: a safety alarm device to prevent children's high temperature suffocation in the car, application number CN201610715108.8). This solution has certain rationality in theory, but it also has many deficiencies and even serious defects. For example, first, the program does not have the early active response capacity, and its passive response will occur after the initial damage has been caused. Second, this scheme has set itself too strict implementation conditions to make it easy to realize: 1. More than 95% of the cars do not have electric doors, so its automatic door opening function cannot be matched; 2. A considerable proportion of negligence occurs in cars that are not equipped with child seats, so the pressure sensors are nowhere to be installed; 3. If every possible seat is equipped with pressure sensors, the economic cost, implementation difficulty and the side effects of false alarm will be too significant; 4. The corresponding coordination between the pressure sensor and the temperature sensor is reasonable in theory, but it faces an environment with many uncertainties rather than a standard assembly line, so its reliability is worrying. Third, also the most serious potential problem is that, the core function of this technical solution is to amplify and broadcast the cries of infants to passersby outside the car to call for help. However, the volume of infants' cries, the sustainable time and the number of passing of nearby are uncertain and uncontrollable. In essence, it requires too much “luck” even to ignore the technical solution's own shortcomings. If no pedestrians pass nearby during the time when infants are able to cry loudly enough, the technical solution has no follow-up means to ensure that infants are rescued, which is a fatal risk.

To sum up, people cannot tolerate this kind of low negligence causing serious harm to the physical and mental health and even life of infants, whereas the known existing technical schemes are not enough to ensure timely and reliable rescue of infants trapped in automobiles.

### SUMMARY OF THE INVENTION

The purpose of this invention is to provide a multilevel automatic distress call system which fundamentally guarantees the life, health and safety of the infants trapped in an automobile due to the negligence of the adult. The purpose of this invention is to be solved through the following technical solutions.

A multilevel automatic distress call system for infants trapped in an automobile, with the following features. This multilevel automatic distress call system includes a power control switch, a controller, timer switches, a first-level radio transmitter, a second-level radio transmitter and a microphone. The power control switch can be closed to put through the power supply of the multilevel automatic distress call system. The microphone used to receive and recognize the cry of infant is connected with the controller. The controller can receive startup signals sent from the microphone. The controller is connected to the timer switches, the first-level radio transmitter, and the second-level ratio transmitters. The radio signals sent by the first-level radio transmitter will be transmitted to a specific private communication equipment for an accurate alarm, while the radio signals sent by the second-level radio transmitter will be transmitted to a specific alarm platform for an emergency distress call. The controller also activates the timer switches to start the timing. When the timing of the timer switches reaches the first-level timing threshold, the controller receiving the startup commands repeatedly sends out the distress signals to the private communication device through the first-level radio transmitter. When the timing of the timer switches reaches the second-level timing threshold, the controller receiving the startup commands repeatedly sends out the distress signals to the alarm platform through the second-level radio transmitter.

The controller receiving the startup commands sends the distress signals repeatedly to the private communication equipment through the first-stage radio transmitter at an interval of 30-60 seconds.

The controller receiving the startup commands repeatedly sends distress signals and the information of the location of the automobile to the private communication equipment through the first-stage radio transmitter.

The multilevel automatic distress call system also includes an audio player connected to the controller. When the timing of the timer switches reaches the second-level timing threshold, the controller receiving the startup commands sends the startup command to the audio player, and then the audio player will continue to broadcast the pre-recorded infant's cry, trying to get the rescue of people passing by.

The multilevel automatic distress call system also includes an automobile electronic control circuit connected with the controller. The automobile electronic control circuit includes an electric control circuit that can lift and lower the glass. When the timing of the timer switches reaches the second-level timing threshold, the controller receiving the startup commands sends to the electric control circuit a command to lower the window glass, so as to avoid the infant's asphyxiation in the automobile.

After the microphone (7) receives and recognizes the crying sound of infants, it will repeatedly issue startup commands to the controller (2) until the multilevel automatic distress call system is cut off (shut off).

The timer switches comprise a first-level timer switch for setting the first-level timing threshold, and a second-level timer switch for setting the second-level timing threshold. The alarm platform comprises the 911 alarm platform.

The configuration of the multilevel automatic distress call system includes a alarming ignition key that is able to provide prompt warning. This alarming ignition key includes a key control unit, which is connected with a sensor, a timer, and a buzzer. The sensor can sense whether the alarming ignition key is pulled out from the keyhole or is away from the automobile, and if so, it sends signals to the key control unit, and then the key control unit starts the timer for timing. When the timer reaches a certain early-warning timing threshold that is before the first-level timing threshold, the timer sends a signal to the key control unit and the key control unit controls the buzzer to warn the automobile owner.

The key control unit is connected with an induction start button, which is set in between the connection of the sensor and the key control unit, enabling the induction start button to control the on/off switch between the sensor and the key control unit.

Compared with the existing technology, this invention has the following advantages:

The proposed invention of multilevel automatic distress call system can not only give accurate alarm through private communication equipment, but also give emergency call and rescue through the alarm platform, so as to ensure that the call and rescue signal sent out can hardly be ignored, making it highly probable for the trapped infant can get timely and reliable rescue. In addition, the additional warning can remind the owner of the vehicle to remember whether there are infants trapped in.

The proposed invention of multilevel automatic distress call system also has the following advantages:

(1) Reliable performance of the equipment. This multilevel automatic distress call system is constituted through the integration of the existing mature technology. The coordination between components is simple and there is no technical difficulty.

(2) Easy to use. The usage completely follows the laws of nature. There is nothing that needs to be learned or trained.

(3) Good economic performance. On-board fixed equipment such as the power supply control switch, the controller, the timer switches, the radio transmitters, the microphones, and the audio player, costs low. In comparison to the relatively high value extension of electronic devices (the private communication equipment and the alarm platform), the on-board equipment has been existing and has already been very popular. They can be used directly without further investment.

(4) Reasonable and reliable working performance. The multilevel automatic distress call system adopts a step-by-step approach, which can effectively balance the rescue effect and the social cost. In addition, the call performance does not leave any loopholes, which can ensure that the automatic distress call signal can hardly be ignored under almost all circumstances, so as to ensure that the harm caused by such negligence accidents to infants can be greatly reduced, and the infant mortality rate can be reduced to zero.

### BRIEF DESCRIPTION OF THE DRAWINGS

FIG. 1 illustrates a schematic diagram of the multilevel automatic distress call system for infants trapped in an automobile proposed in the present invention.

FIG. 2 illustrates a schematic diagram of a warning principle for the warning automobile ignition key adopted by the present invention.

### DETAILED DESCRIPTION OF THE INVENTION

In the figures: 1—power control switch; 2—controller; 3—first-level timer switch; 4—second-level timer switch; 5—first-level radio transmitter; 6—second-level radio transmitter; 7—microphone; 8—private communication equipment; 9—alarm platform; 10—audio player; 11—automobile electronic circuit; 12—key control unit; 121—sensor; 122—timer; 123—buzzer; 124—induction start button.

The current invention is further explained below in combination with the appended drawings and instances.

FIG. 1 illustrates a multilevel automatic distress call system for infants trapped in an automobile. This multilevel automatic distress call system includes a power control switch 1, a controller 2, timer switches, a first-level radio transmitter 5, a second-level radio transmitter 6 and a microphone 7. The power control switch 1 is in reverse linkage with the ignition circuit of the automobile, and the power control switch 1 can be closed to put through the power supply of the multilevel automatic distress call system. The microphone 7 used to receive and recognize the cry of infant is connected with the controller 2. The controller 2 can receive startup signals sent from the microphone 7, and the microphone 7 will keep sending startup commands to the controller 2, until the multilevel automatic distress call system is cut off (shut off). The controller 2 is connected to the timer switches, the first-level radio transmitter 5, and the second-level ratio transmitters 6. The radio signals sent by the first-level radio transmitter 5 will be transmitted to a specific private communication equipment 8 for an accurate alarm, while the radio signals sent by the second-level radio transmitter 6 will be transmitted to a specific alarm platform 9 for an emergency distress call. The controller 2 also activates the timer switches to start the timing. When the timing of the timer switches reaches the first-level timing threshold, the controller 2 receiving the startup commands repeatedly sends out the distress signals to the private communication device 8 through the first-level radio transmitter 5. When the timing of the timer switches reaches the second-level timing threshold, the controller 2 receiving the startup commands repeatedly sends out the distress signals to the alarm platform 9 through the second-level radio transmitter 6.

Furthermore, the controller 2 receiving the startup commands sends the distress signals repeatedly to the private communication equipment 8 through the first-stage radio transmitter 5 at an interval of 30-60 seconds. Based on the distress message, the controller 2 receiving the startup commands repeatedly sends distress signals and the information of the location of the automobile to the private communication equipment 8 through the first-stage radio transmitter 5.

On the basis of the above structure, the multilevel automatic distress call system also includes an audio player 10 connected to the controller 2. When the timing of the timer switches reaches the second-level timing threshold, the controller 2 receiving the startup commands sends the startup command to the audio player 10, and then the audio player 10 will continue to broadcast the pre-recorded infant's cry, trying to get the rescue of people passing by. Similarly, the multilevel automatic distress call system also includes an automobile electronic control circuit 11 connected with the controller 2.

The automobile electronic control circuit 11 includes an electric control circuit that can lift and lower the glass, an electric circuit to turn on the emergency flashers or the vehicle horn. When the timing of the timer switches reaches the second-level timing threshold, the controller 2 receiving the startup commands sends to the electric control circuit a command to lower the window glass, so as to avoid the infant's asphyxiation in the automobile.

Moreover, the timer switches comprise a first-level timer switch 3 for setting the first-level timing threshold, and a second-level timer switch 4 for setting the second-level timing threshold. The alarm platform 9 comprises the 911 alarm platform.

In addition, on the basis of the second level of the above multilevel automatic distress call system, a prompt early warning is also added. The configuration of the multilevel automatic distress call system includes an alarming ignition key that is able to provide prompt warning, as shown in FIG. 2. This alarming ignition key includes a key control unit 12, which is connected with a sensor 121, a timer 122, and a buzzer 123. The sensor 121 can sense whether the alarming ignition key is pulled out from the keyhole or is away from the automobile, and if so, it sends signals to the key control unit 12, and then the key control unit 12 starts the timer 122 for timing. When the timer 122 reaches a certain early-warning timing threshold that is before the first-level timing threshold, the timer 122 sends a signal to the key control unit 12 and the key control unit 12 controls the buzzer 123 to warn the automobile owner. Moreover, since not everybody needs this warning function, the key control unit 12 is connected with an induction start button 124, which is set in between the connection of the sensor 121 and the key control unit 12, enabling the induction start button 124 to control the on/off switch between the sensor 121 and the key control unit 12.

In the multilevel automatic distress call system proposed in the present invention, the power control switch 1 is responsible for managing the power supply of on-board fixed equipment. It has a specific linkage relationship with the ignition system of the vehicle. When the vehicle is in operation or when the ignition key is inserted into the keyhole, the power supply is disconnected. When the ignition key is pulled out or away from the vehicle, i.e., when the vehicle is turned off, the power control switch 1 closes and switches on the power supply of the multilevel automatic distress call system. The above settings have no technical difficulties. The advantages of the above settings are as follows: When an adult is in the vehicle, this multilevel automatic distress call system has no power, and it will not trigger a false alarm. When the adult leaves the vehicle, the multilevel automatic distress call system is automatically switched on and put on alert, no matter if the adult is aware of it.

Assuming that the setting of the first-level timing threshold is 8 minutes, and the second-level timing threshold is 18 minutes (time values are provided for reference only). When the power is on, the controller 2 will simultaneously start two timer switches, one is 0˜8 minutes, and the other is 0˜18 minutes. The function of timer switches is highly similar to the countdown function in an ordinary smartphone. Here's how it works: When it arrives (or exceeds) 8 minutes, controller 2 will switch on the circuit of the first-level radio transmitter 5; When it arrives (or exceeds) 18 minutes, it will further switch on the second-level radio transmitter 6 and audio player 10, open the vehicle electric circuit 7, etc. In other words, controller 2 sectionally controls the work of the first-level radio transmitter 5, the second-level radio transmitter 6, the audio player 10 and the automobile electronic control circuit 7.

In the first period, 0˜8 minutes, the circuit is switched off, so the first-level radio transmitter 5, the second-level radio transmitter 6, the audio player 10 and the automotive electronic control circuit 7 will not work.

In the second period (more than 8 minutes but less than 18 minutes), the circuit of the first-level radio transmitter 5 can be switched on to work, but whether it starts to work depends on whether there are startup commands.

In the third time period (reaching or exceeding 18 minutes), the circuit is switched on, so the first-level radio transmitter 5, the second-level radio transmitter 6, the audio player 10 and the automobile electronic control circuit 7 can all work, but whether they start to work also depends on whether there is a startup command.

In the multilevel automatic distress call system for infants trapped in an automobile proposed in the present patent, it is the microphone 7 that actually issues the startup command After the power of the microphone 7 is switched on, it immediately collects all kinds of sound automatically. When it identifies the crying sound of infants, it transmits it to the “startup command” and sends to the controller 2. It repeatedly sends the command once per minute. Even if the infant stops crying, the startup commands will continue to be sent, until the multilevel automatic distress call system is cut off.

The function is highly similar to the voice processing function in an ordinary smartphone. The program identifies the sound of a crying infant and transforms it to the startup command, being not a technical difficulty.

Special emphasis should be laid on the high necessity and advancement of using infant's cry as the startup command. The key points are as follows. The first one is high reliability. The infant trapped in an automobile will instinctively cry at the first time, and people can hardly find a timelier and more reliable source of signal than the sound of cry. The timeliness and reliability are the foundation to ensure the successful operation of the system proposed in the current invention. The second point is the significant low probability of a false alarm. All the sound from outside of the automobile may be detected by the microphone 7, but the probability of an infant passing by the vehicle while crying loudly is extremely low, which can greatly reduce the probability of false alarm of the system of the proposed invention.

The design principle of the present invention is as follows. 1. If there is an infant trapped in the automobile, then the infant is inevitable to cry; 2. If there is a crying sound of the infant, it can trigger the multi-level automatic distress call system to work; 3. In order to get the best effect, the multi-level automatic distress call system adopts the working mode of gradually upgrading the alarm level.

In the following, we use an instance of an automobile with an alarming ignition key to elaborate the levels in the multilevel automatic distress call system. We assume that the first-level timing threshold is 8 minutes and the second-level timing threshold is 18 minutes.

Level 1: Prompt early warning, from 0 to 8 minutes.

As mentioned before, when the adult locks the vehicle and leaves, the smart microphone 7 will automatically go on alert. If the cry is detected, it will immediately send the startup command to the controller 2, but the multi-level automatic distress call system will not work within 8 minutes. This is a rational and active choice rather than an oversight, for the following reasons:

1. In the vast majority of cases, this is not negligence but temporary legitimate needs of the driver (e.g., going to the restroom). It is unnecessary to trigger the alarm at this moment, or it will have a negative social impact.

2. If it is a negligence indeed, such a short time is not likely to cause harm to infants, so it is advisable to use mild methods to solve the problem.

Therefore, at this level, the present invention will adopt a gentle prompt warning for the possible negligence of the adult, and it requires the use of the alarming vehicle ignition key. When the vehicle ignition key senses itself leaving the keyhole, the timer 122 begins to work. When the time reaches 3 minutes and 5 minutes, let buzzer 123 make several buzzers (or maybe other sounds of course).

We know that it is common for drivers to carry their vehicle ignition keys and hear the sound, and this prompt will not have a negative effect on anyone else.

It is well known that short-term memory is generally stronger than long-term memory. It is easy to fade or completely forget the advice given years, months or even days ago, but with a little warning, it is easy to recall what just happened. If the baby was forgotten in the car a few minutes ago, the probability of association is very high, and at the moment the driver is very close to the car, turning around within a few minutes will be able to solve the problem peacefully. That is to say, through the early warning of the multilevel automatic distress call system of the present invention, the vast majority of negligence crises are expected to be resolved in the absence of social influence.

However, social conditions are complex. It is still possible for people to miss or misinterpret these prompt warnings in situations of high stress, anger, sadness or physical discomfort. A mere 1% of negligence or misjudgment could have led to tragedy. Therefore, the multilevel automatic distress call system of the present invention only regards it as one but not all of the effective means. In order to ensure that trapped infants can effectively call for help under any circumstances, the multilevel automatic distress call system of the present invention will persist in using subsequent technical means to eliminate any potential vulnerabilities.

Level 2: Accurate alarm.

If the first alarming does not work, the circuit of the first-level radio transmitter 5 is switched on by 8 minutes. If the smart microphone 7 has issued the “startup command”, the first-level radio transmitter 5 will repeatedly send the Wi-Fi signal to the outside at the frequency of once a minute, with the content of “car location” and “mayday”. The fixed-point receiver is the epitaxial electronic device, i.e., the private communication equipment 8, such as a mobile phone. The method is highly similar to sending a message to “friends in social media”. “Social media group friends” should be set in advance. The group of friends of the private vehicle could be the parents, grandparents and/or other custodians of the infant. The group friends of a kindergarten school bus could be bus drivers, school principal, teachers, etc. After the Wi-Fi signal is sent, the relevant legal or responsible guardian should be able to receive it. They can usually know who is nearest to the car and immediately take active rescue action. They can open the car door within 0 to 18 minutes, with a high probability of completing the rescue.

If the rescue is completed within 0 to 18 minutes, the infant will not be significantly harmed, nor will there be any obvious social impact.

Level 3: Emergency call level.

A state of emergency can be declared for the safety of the trapped infant if both the first and second level rescue efforts fail for some reason.

When the time reaches 18 minutes, the controller 2 will connect the circuit of the rear second-level radio transmitter 6 and/or the circuit of the audio player 10 and/or the electronic control circuit 11 of the vehicle.

In this case, the second-level radio transmitter 6 begins sending repeated distress signals to the alarm platform 9 (public alarm platforms 911). Audio player 10 will continue to send pre-recorded cries infants to the outside world in an effort to get nearby help from passers-by. The car's electric glass windows will be lowered, automatically avoiding the infant's asphyxiation and making it easier for outside rescuers to open the doors.

The biggest advantage of the “emergency call levels” of the present invention is that it can ensure that the trapped infant can get reliable rescue. The disadvantage of it is that it may have a greater social impact.

Therefore, the design idea of the present invention is: this system must have a guaranteed level of distress call, but it should be put after the step of “prompt early warning” and the step of “accurate alarm”.

This multilevel automatic distress call system for infants trapped in an automobile proposed in the present invention is a brand-new technical scheme, which is completed by integrating a variety of existing mature technologies by practical means. The so-called existing mature technology refers to those that the technical personnel in this field, without creative thinking and creative work, can understand and implement. The specification of the present invention will only introduce the integration principle and method of the existing mature technology, the interaction and cooperation with the natural activity rules of relevant personnel, and the effect that can be achieved. It will not elaborate on the cited existing mature technologies themselves.

The above instance is presented only to explain the technical ideas of the present invention and cannot limit the protection scope of the present invention. Any modification made on the basis of the technical scheme in accordance with the technical ideas proposed by the present invention shall fall within the protection scope of the present invention. The technologies not involved in the present invention can be realized by existing technologies.

1. A multilevel automatic distress call system for an infant trapped in an automobile, the system comprising:
a. a power supply;
b. a power control switch, wherein the power control switch can be closed to put through the power supply of the multilevel automatic distress call system;
c. a controller;
d. a plurality of timer switches;
e. a first-level radio transmitter;
f. a second-level radio transmitter;
g. a microphone operatively connected to the controller, wherein the microphone is configured to receive and recognize a cry of an infant;
h. the controller is configured to receive startup signals sent from the microphone;
i. the controller is further configured to activate the plurality of timer switches to start timing;
j. the controller is operatively connected to the plurality of timer switches, the first-level radio transmitter, and the second-level ratio transmitter;
k. the first-level radio transmitter is configured to transmit radio signals to a private communication equipment for an accurate alarm;
l. the second-level radio transmitter is configured to transmit radio signals to an alarm platform for an emergency distress call;
m. when the timing of the plurality of timer switches reaches a first-level timing threshold, the controller repeatedly transmits distress signals to the private communication equipment through the first-level radio transmitter; and
n. when the timing of the plurality of timer switches reaches a second-level timing threshold, the controller repeatedly transmits distress signals to the alarm platform through the second-level radio transmitter.

2. The system of claim 1, wherein the controller repeatedly transmits the distress signals to the private communication equipment through the first-level radio transmitter at an interval of at least 30 seconds and no greater than 60 seconds.

3. The system of claim 1, wherein the controller is further configured to repeatedly transmit information on the location of the automobile to the private communication equipment through the first-level radio transmitter.

4. The system of claim 2, wherein the controller is further configured to repeatedly transmit information on the location of the automobile to the private communication equipment through the first-level radio transmitter.

5. The system of claim 1 further comprising:
a. an audio player operatively connected to the controller; and
b. when the timing of the plurality of timer switches reaches the second-level timing threshold, the controller transmits the startup signals to the audio player, and the audio player repeatedly broadcasts a pre-recorded infant's cry.

6. The system of claim 1 further comprising:
a. an automobile electronic control circuit comprising an electric control circuit configured to lift and lower window glass;
b. the automobile electronic control circuit is operatively connected to the controller; and
c. when the timing of the plurality of timer switches reaches the second-level timing threshold, the controller transmits a signal to the electric control circuit to lower the window glass to prevent asphyxiation of an infant.

7. The system of claim 5 further comprising:
a. an automobile electronic control circuit comprising an electric control circuit configured to lift and lower window glass;
b. the automobile electronic control circuit is operatively connected to the controller; and
c. when the timing of the plurality of timer switches reaches the second-level timing threshold, the controller transmits a signal to the electric control circuit to lower the window glass to prevent asphyxiation of an infant.

8. The system of claim 1 wherein after the microphone receives and recognizes a cry of an infant, the microphone will repeatedly transmit startup signals to the controller until the system is shut off;

9. The system of claim 1 wherein each of the timer switches comprises:
a. a first-level timer switch for setting the first-level timing threshold; and
b. a second-level timer switch for setting the second-level timing threshold.

10. The system of claim 1 wherein the alarm platform comprises a 911 alarm platform.

11. The system of claim 1 further comprising:
a. an alarming ignition key configured to provide prompt warning;
b. the alarming ignition key comprises a key control unit operatively connected to a sensor, a timer, and a buzzer;
c. the sensor is configured to sense whether the alarming ignition key is removed from the keyhole or away from the automobile;
d. when the sensor senses that the alarming ignition key is removed from the keyhole or away from the automobile, the alarming ignition key transmits signals to the key control unit to start the timer; and
e. when the timer reaches an early-warning timing threshold before the first-level timing threshold, the timer transmits a signal to the key control unit, and the key control unit activates the buzzer to warn the owner of the automobile.

12. The system of claim 11 wherein the key control unit is operatively connected to an induction start button, the induction start button being located between the sensor and the key control unit, enabling the induction start button to control an on/off switch between the sensor and the key control unit.
